(19) United States
(12) Patent Application Publication
(10) Pub. No.: US 2019/0196671 A1
(43) Pub. Date: Jun. 27, 2019

(54) CONTENT PRESENTATION FOR A NETWORK-BASED SERVICE ON A MOBILE COMPUTING DEVICE

(71) Applicant: Uber Technologies, Inc., San Francisco, CA (US)

(72) Inventors: Yuhki Yamashita, San Francisco, CA (US); Didier Patrick Hilhorst, San Francisco, CA (US); Bryant Jow, San Francisco, CA (US); Peter Ng, San Francisco, CA (US)

(21) Appl. No.: 16/291,460

(22) Filed: Mar. 4, 2019

Related U.S. Application Data
(63) Continuation of application No. 15/395,647, filed on Dec. 30, 2016.
(60) Provisional application No. 62/399,836, filed on Sep. 26, 2016.

(51) Int. Cl. G06F 3/0482; G06F 3/048; H04L 29/08; H04W 4/40; G01C 21/36; G06Q 10/06; G06Q 50/30; G06F 9/451; H04W 4/02; G08G 1/00

(52) U.S. Cl. CPC G06F 3/0482; G06F 3/048; H04L 67/16; H04W 4/40; H04L 67/18; G01C 21/3664; G01C 21/26; G06Q 50/30; G06F 9/451; H04W 4/02; G08G 1/202; H04L 67/306; G06F 2203/04803; G06Q 10/063114

(57) ABSTRACT

A mobile computing device can receive a set of service progress data corresponding to a transport service for a user of the mobile computing device and can present a user interface in a first configuration that includes a first section for displaying a map and a second section for displaying information related to the transport service, including a first set of information pertaining to a service provider identified by a remote computing system. In response to detecting the user input on the user interface, the mobile computing device can pivot the user interface from the first configuration to a second configuration by expanding the second section to replace at least a portion of the first section. The expanded second section can display the first set of information and service information of the transport service using at least a portion of the set of service progress data.

### CROSS-REFERENCE TO RELATED APPLICATIONS

This application is a continuation of U.S. patent application Ser. No. 15/395,647, filed Dec. 30, 2016, titled “CUSTOMIZED CONTENT GENERATION FOR A USER INTERFACE FOR A NETWORK SERVICE,” which claims the benefit of Provisional U.S. Patent Application Ser. No. 62/399,836, filed Sep. 26, 2016; the aforementioned priority applications being hereby incorporated by reference in their respective entirety.

### BACKGROUND

Users typically operate mobile computing devices to use network services. While such services are being rendered, user applications executing on these mobile computing devices typically display generic information regarding the services being rendered. Users must exit from or suspend the user applications to perform tasks such as listening to music and reading the news.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network system in communication with user and provider devices, in accordance with examples described herein;

FIG. 2 is a flow chart describing an example method of generating customized user content for display on a user device, according to examples described herein;

FIG. 3 is a block diagram illustrating an example user device executing a designated user application for a network service, as described herein;

FIG. 4 is a flow chart describing an example method of displaying customized user content on a user device, according to examples described herein;

FIG. 5 is a screenshot illustrating an example user interface on a user device, according to examples described herein;

FIGS. 6A through 6D are additional screenshots illustrating additional example user interfaces on a user device, according to examples described herein;

FIG. 7 is a block diagram illustrating an example provider device executing a designated service provider application for a network service, as described herein; and

FIG. 8 is a block diagram illustrating a computer system upon which examples described herein may be implemented.

### DETAILED DESCRIPTION

A network system is provided herein that manages a network service (e.g., a transport service, a delivery service, etc.) linking available service providers (e.g., drivers and/or autonomous vehicles (AVs)) with requesting users (e.g., riders, service requesters) throughout a given region (e.g., a metroplex such as the San Francisco Bay Area). In doing so, the network system can receive requests for service from requesting users via a designated user application executing on the users' mobile computing devices (“user devices”). Based on a start location (e.g., a pick-up location where the requesting user rendezvouses with a selected service provider) determined from a user input or from one or more geo-aware resources on the user device, the network system can identify a number of proximate available service providers and transmit an invitation to one or more provider devices of the proximate available service providers to service the service request.

In determining an optimal service provider to service a given service request, the network system can identify a plurality of candidate service providers to service the service request based on a start location indicated in the service request. For example, the network system can determine a geo-fence surrounding the start location (or a geo-fence defined by a radius away from the start location), identify a set of candidate service providers (e.g., twenty or thirty service providers within the geo-fence), and select an optimal service provider (e.g., closest service provider to the start location, service provider with the shortest estimated travel time from the start location, service provider traveling or en-route to a location within a specified distance or specified travel time to a service location, etc.) from the candidate service providers to service the service request. In many examples, the service providers can either accept or decline the invitation based on, for example, the route being too long or impractical for the service provider.

According to embodiments, the network system generates content data for display on the user devices. The generated content data is transmitted to the user devices over one or more secure communication links (e.g., a cellular network connection). As used herein, content data can correspond to data used by the user device to display user interface features within the user application (e.g., a map, a status bar, content cards, etc.) or outside the user application (e.g., a mobile operating system notification). In embodiments described herein, the content data can include data pertaining to the network service arranged by the network system. For instance, the content data can include data regarding information pertaining to the optimal service provider selected to service the service request or information pertaining to service progress (e.g., an estimated time of arrival (ETA) to a service location, etc.). In addition, the content data can include data from third party sources such as a news article database, a music streaming service, a video streaming service, and the like. The content data can further include other data cached or stored by the network system.

In various implementations, the network system manages a user profile for each of a plurality of users of the network system by, for example, maintaining records of historical usage data, and/or user-entered or projected personal preferences (e.g., favorite or frequently used service start or service locations, favorite music genre, favorite source for news articles, etc.). And according to embodiments, the network system can also generate service progress information (e.g., ETA to the service location, ETA of service provider arriving at the start location, etc.).

In examples described herein, the network system can generate customized content data such that each user device can display content and user interface features that are particularly relevant to each individual user. The content data can be tailored for an individual user, a particular service session, a specific location (e.g., start or service location, or a current location on the service route), and the like. For instance, the network system can generate content data based, at least in part, on one or more of information from the user profile, service progress information, and/or information regarding the service location (e.g., stopping locations, destination location). By leveraging information such as service progress information and user profile information, the network system can generate content data for presentation on the user device that is particularly relevant or useful to the user at any particular time before, during, or after the service arranged by the network system. As an example, the network system can generate content data based on the service location. In this manner, content data regarding points-of-interest recommendations (e.g., restaurants, venues, parks, etc.) nearby to the service location can be generated by the network system for display on the user device while the user is en-route to the service location. Furthermore, by leveraging such information, the network system can generate content data by selecting content that is suitable (e.g., of an appropriate length or duration) for viewing or consumption by the user. For example, the network system can compare lengths of audio content from an audio streaming service or video content from a video streaming service against the service progress information (e.g., ETA to the service location) and select audio content or video content having appropriate lengths in generating the content data. In this manner, the user can be presented with videos from the video streaming service that, for example, can be viewed or consumed in their entirety before the user is estimated to arrive at the service location.

According to embodiments, using the content data received from the network system, the user device can display or present to the user various user interface features for the user to view information from or interact with the network system or third party sources. With respect to the network system, user interface features presented on the user device can allow the user to input or confirm a start location, a service location, a service type, and the like. In some examples, the service type can correspond to a class of service (e.g., type of vehicle of a transport request, ride-pooling, luxury vehicle, etc.). The user can also submit a request for the network service (e.g., a service request) using the user interface features presented in the user application. In addition, the user can view information (e.g., service progress status, selected service provider information, etc.) and receive confirmations (e.g., service provider confirmation) pertaining to the request for service and the service arranged by the network system through user interface features presented in the user application. The user can also receive information regarding the network service (e.g., promotions, discounts, service announcements, etc.) through the user interface features presented on the user device. With respect to third party sources, user interface features presented in the user application can allow the user to view information from or interact with third party services, including audio or video streaming services, social media services, weather reporting services, news services, communication services (e.g., messaging services), food delivery services, reservation services (e.g., restaurant or venue reservation services), and the like.

In various examples, the user devices are configured to display or present various user interface features using the content data generated by the network system. Examples of user interface features include maps, status bars (e.g., a service progress status bar), content cards, etc. Each content card can contain content about a subject, including text, hyperlinks, videos, and/or images. According to embodiments, the user interface features allow for interactions by the user. For instance, the user can select a user interface feature to view additional information not initially shown on the user interface feature.

In certain implementations, the user device can pivot the user interface of the user application between various configurations to optimize the presentation of content or information on the screen of the user device. In another example, the pivoting of the user interface can be performed based on service progress information. As one example, the user interface displayed to the user can be pivoted to display a service progress bar rather than a map based on service progress information indicating that the service provider selected by the network system has arrived at the start location (e.g., user has been picked up by the selected service provider). The pivoting of the user interface can also be performed based on user input. For instance, in response to user input corresponding to a swipe up or swipe down input gesture within the user application (e.g., indicating that the user would like to see additional information), the user interface can be pivoted from the service progress bar to a map showing additional information regarding the route and/or intermediate locations (e.g., pick-up or drop-off locations for ride-pooling users) on route. In this manner, the user application can optimize the arrangement of user interface features to optimally present content that is most relevant to (e.g., as indicated by service progress information) or desired by the user (e.g., as indicated by user input).

Among other benefits, the examples described herein achieve a technical effect of improving user experience while utilizing a network service. By leveraging information particular to an individual user or a service session to generate content data for presentation on the individual user's device, the embodiments described herein allow the user experience in using the user application to be enriched. In addition, by allowing the user to view information from or interact with third party sources/services, the user can accomplish useful tasks before, during, and after the service session without leaving the user application, thereby streamlining and simplifying the user experience. Furthermore, by pivoting the user interface to re-arrange user interface features based on user input and/or service progress information, the user application can optimally present content that is most relevant to or desired by the user, further improving the user experience.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Some examples are referenced herein in context of an autonomous vehicle (AV) or self-driving vehicle (SDV). An AV or SDV refers to any vehicle which is operated in a state of automation with respect to steering and propulsion. Different levels of autonomy may exist with respect to AVs. For example, some vehicles may enable automation in limited scenarios, such as on highways, provided that service providers are present in the vehicle. More advanced AVs can drive without any human assistance from within or external to the vehicle. Such vehicles are often required to make advanced determinations regarding how the vehicle behaves given challenging surroundings of the vehicle environment.

System Descriptions

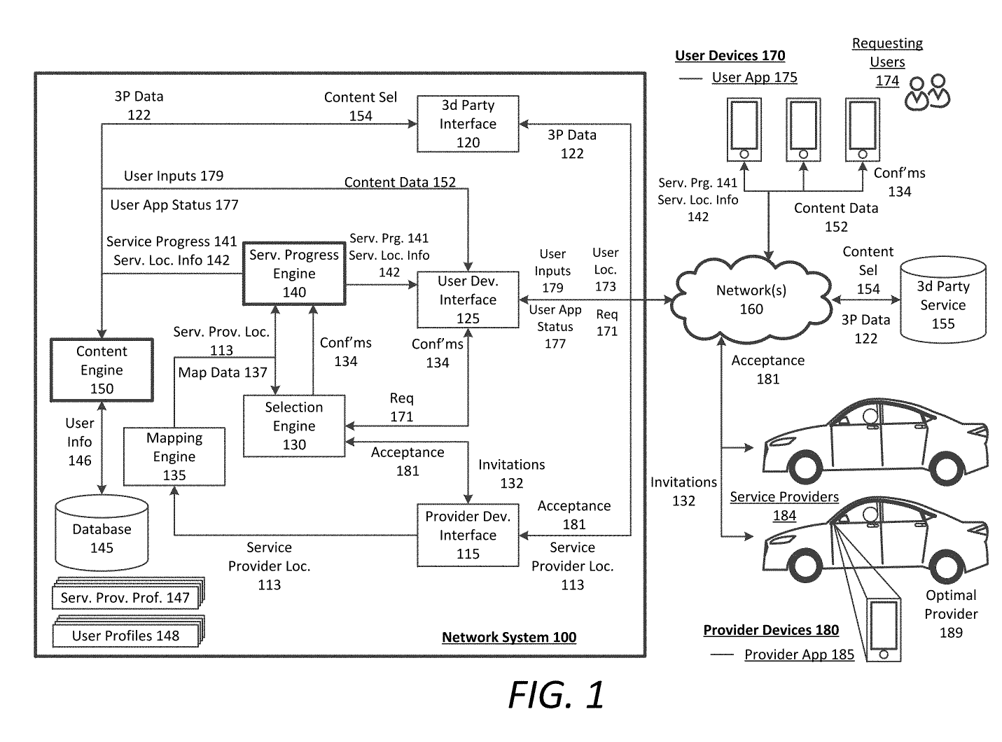

FIG. 1 is a block diagram illustrating an example network system in communication with user and provider devices, in accordance with examples described herein. The network system 100 can manage a network service that connects requesting users 174 with service providers 184 that are available to service the users' service requests 171. The network service can provide a platform that enables on-demand services (e.g., ride-sharing services, delivery services, etc.) between requesting users 174 and available service providers 184 by way of a user application 175 executing on the user devices 170, and a service provider application 185 executing on the provider devices 180. As used herein, a user device 170 and a provider device 180 can comprise a computing device with functionality to execute a designated application corresponding to the network service managed by the network system 100. In many examples, the user device 170 and the provider device 180 can comprise mobile computing devices, such as smartphones, tablet computers, VR or AR headsets, on-board computing systems of vehicles, smart watches, and the like.

The network system 100 can include a user device interface 125 to communicate with user devices 170 over one or more networks 160 via a user application 175. According to examples, a requesting user 174 wishing to utilize the network service can launch the user application 175 and transmit a service request 171 over the network 160 to the network system 100. In certain implementations, the requesting user 174 can view multiple different service types managed by the network system 100, such as ride-pooling, a basic ride share service, a luxury vehicle service, a van or large vehicle service, a professional service provider service (e.g., where the service provider is certified), a self-driving vehicle transport service, and the like. The network system 100 can utilize the service provider locations 113 to provide the user devices 170 with ETA data of proximate service providers for each respective service. For example, the user application 175 can enable the user 174 to scroll through each service type. In response to a soft selection of a particular service type, the network system 100 can provide ETA data on a user interface of the user app 175 that indicates an ETA of the closest service provider for the service type, and/or the locations of all proximate available service providers for that service type. As the user scrolls through each service type, the user interface can update to show visual representations of service providers for that service type on a map centered around the user 174 or a start location set by the user. The user can interact with the user interface of the user app 175 to select a particular service type, and transmit a service request 171.

In certain implementations, the user device interface 125 can receive user input 179 and user application status 177 from the user devices 170 over the network 160. Users' 174 interactions with the user application 175, including with any content displayed therein, can be transmitted as user inputs 179. Such inputs can include selections, text inputs, swipes, gestures, uploads, and the like. User application status 177 can correspond to signals or data indicating a status of the user application 175. For instance, when the user 174 first opens the user application 175, the user application 175 can cause the user device 170 to transmit a synchronization signal as user application status 177 indicating that the user application is open. In addition, the user application status 177 can indicate that the user 174 is viewing or interacting with the home screen of the user application 175. Likewise, the user application status 177 can also indicate that the user 174 is entering a service location, for example.

In some examples, the service request 171 can include a start location within a given region (e.g., a metropolitan area managed by one or more datacenters corresponding to the network system 100) at which a matched service provider is to rendezvous with the requesting user 174. The start location can be inputted by the user by setting a location pin on a user interface of the user app 175, or can be determined by a current location of the requesting user 174 (e.g., utilizing location-based resources of the user device 170). Additionally, the requesting user 174 can further input a service location during or after submitting the service request 171.

In various implementations, the network system 100 can further include a selection engine 130 to process the service requests 171 in order to select service providers 184 to service the service requests 171. The network system 100 can include a provider device interface 115 to communicate with the provider devices 180 via the service provider application 185. In accordance with various examples, the provider devices 180 can transmit real-time location information using geo-aware resources of the provider devices 180 (e.g., GPS or GLONASS). These service provider locations 113 can be utilized by the selection engine 130 to identify a set of candidate service providers 184, in relation to the start location, that can service the service request 171.

In certain implementations, the network system 100 can also select a proximate self-driving vehicle (SDV) to service the service request 171. Thus, the pool of proximate candidate service providers in relation to a start location can also include one or more SDVs operating throughout the given region.

In some aspects, the network system 100 can include a mapping engine 135, or can utilize a third-party mapping service, to generate map data 137 and or traffic data in the environment surrounding the start location. The mapping engine 135 can receive the service provider locations 113 and input them onto the map data 137. The selection engine 130 can utilize the current service providers locations 113 in the map data 137 (e.g., by setting a geo-fence surrounding the start location) in order to select an optimal service provider 189 to service the service request 171. As provided herein, the optimal service provider 189 can be a service provider that is closest to the requesting user 174 with respect to distance or time, or can be a proximate service provider that is optimal for other reasons, such as the service provider's experience, the amount of time the service provider has been on the clock, the service provider's current earnings, and the like.

Once the optimal service provider 189 is selected, the selection engine 130 can generate an invitation 132 to service the service request 171, and transmit the invitation 132 to the optimal service provider's 189 provider device 180 via the service provider application 185. Upon receiving the invitation 132, the optimal service provider 189 can either accept or reject the invitation 132. Rejection of the invitation 132 can cause the selection engine 130 to determine another optimal service provider from the candidate set of service providers 184 to service the service request 171. However, if the optimal service provider accepts (e.g., via an acceptance input), then the acceptance input 181 can be transmitted back to the selection engine 130, which can generate and transmit a confirmation 134 of the optimal service provider 189 to the requesting user 174 via the user application 175 on the requesting user's 174 computing device 170.

In various implementations, the network system 100 can further include a database 145 storing user profiles 148 including historical information specific to the individual users 174 of the on-demand network service. Such information can include user preferences of service types, routine routes, start locations, and service locations, work addresses, home addresses, addresses of frequently used service locations (e.g., a gym, grocery store, mall, local airport, sports arena or stadium, concert venue, local parks, and the like). Such information can also include special or individualized promotions and/or discounts offered to a user. In addition, the database 145 can further store service provider profiles 147 indicating information specific to individual service providers, such as service type, service qualifications, earnings data, and service provider experience.

In the examples described herein, the network system 100 can include a service progress engine 140 that determines and outputs service progress information 141 and service location information 142. Service progress information 141 can include information, parameters, or data pertaining to the status of the service. For instance, service progress information 141 can include an estimated time of arrival (ETA) at a service location of the service facilitated by the network system 100. ETA can be a specific time of the day (e.g., 4 pm) or can be an amount of time remaining (e.g., 30 minutes). Service progress information can further include information pertaining to intermediate locations on the route, a status of the selected service provider (e.g., whether the service provider is en-route to the start location, whether the service provider accepted the service request 171, and/or whether the service provider has rendezvoused with the requesting user etc.).

In various implementations, the service progress engine 140 can determine service progress information 141 using real-time information from geo-aware resources of the provider device 180 (e.g., service provider location 113) or the user device 170 (e.g., user location 173). The network system 100 can repeatedly communicate with the provider device 180 and the user device 170 to receive the real-time information to continuously update the service progress information 141. In this manner, up-to-date information pertaining to the progress of the service can be determined and transmitted to the user device 170.

In certain examples, the service progress engine 140 can take into account current or predicted traffic conditions to determine service progress information 141. Furthermore, in the event that the user 174 modifies the service location during the service or if an intermediate location is added to the route (e.g., to rendezvous with a service-pooling or service-sharing user), the service progress engine 140 can be configured to update the service progress information 141 in response. The service progress information 141 can be transmitted by the service progress engine 140 to the user device interface 125 and subsequently to the user device 170 over the network 160.

Service location information 142 can include information pertaining to the service location of the requested service. The service location can be entered by the user before or during the rendering of the service. The user can further modify the service location during the rendering of the service. In the event that the user makes modifications to the service location, the service location information 142 can be dynamically updated by the service progress engine 140 in response to the user's modification.

In various implementations, the network system 100 can include a content engine 150 that generates content data 152 for presenting one or more user interface features on the user devices 170. The content data 152 is transmitted to the user device interface 125, which transmits the content data 152 to the user devices 170 via network 160. The one or more user interface features can include features that enable users to input service locations and/or start locations within the user application 175 and features that enable users to submit service requests 171. For instance, the content data 152 generated by the content engine 150 can be used by the user device 170 to display an interactive map, a service progress bar, one or more content cards, and the like.

In some examples, the content engine 150 can generate content data 152 based, at least in part, on information specific to each individual user 174 (e.g., information derived from user profiles 148, information stored within the user profiles, etc.). Such information can be transmitted to the content engine 150 as user information 146 from the database 145 that stores the user profiles 148. In this manner, the content engine 150 can customize or individualize content data 152 generated for each user device 170. As provided herein, the user information 146 can comprise historical data corresponding to the user's 174 utilization of the on-demand network service. In analyzing the user information 146, the content engine 150 can identify user profile 148 information relevant to generating content for presentation to the user 174 on the user device 170. For instance, the content engine 150 can determine from user information 146 that a user is targeted for a specific promotion or discount for use with the on-demand network service (e.g., 5% off regular price for a particular service type). In response, the content engine 150 can display information pertaining to the promotion or discount to the user 174 (e.g., when the user 174 opens the user application 175 on the user device 170), as well as the specific terms and conditions associated with the promotion or discount. As another example, the content engine 150 can determine from the user information 146 that a user frequently requests service to a particular location based on historical information stored in user profile 148 (e.g., a shopping mall). In response, the content engine 150 can generate content pertaining to individualized promotions or discounts for service to the particular location (e.g., 10% off) for the user. In addition to or as an alternative, the user can receive content pertaining to discounts for use at third-party entities (e.g., a department store, a restaurant) at or near the particular location. As described herein, the content engine 150 can leverage third-party sources or services (e.g., data sources or services provided by the shopping mall, the department store, or the restaurant) in generating such content.

According to embodiments, the content engine 150 can generate content data 152 based on service progress information 141 and/or service location information 142. With respect to service progress information 141 (e.g., service status, ETA information, time remaining en-route, time elapsed, etc.), the content engine 150 can generate data pertaining to content that is appropriate for viewing or consumption based on the service progress information 141 (e.g., ETA to service location or time remaining en-route). For instance, the content engine 150 can determine or estimate respective lengths for each of a plurality of articles of content (e.g., news articles, video and audio content). The content engine 150 can select content from the plurality of articles of content to generate content data 152 based on a comparison between the respective lengths of plurality of articles of content and the service progress information 141. For instance, if the service progress information 141 indicates an ETA to the service location of four minutes, the content engine 150 can select news articles estimated to take four minutes or less to read. As another example, the content engine 150 can select video content to generate content data 152 based on the length of the video content and the service progress information 141. In this manner, the content engine 150 can generate content data 152 pertaining to content that can be properly viewed or consumed by the user in the time remaining for the service (e.g., time remaining until the service provider arrives at the start location or time remaining until the user arrives at the service location).

With respect to service location information 142, the content engine can generate content data 152 based on the service location and/or points-of-interest near the service location. For instance, the content engine 150 can determine that the service location inputted by the user 174 is a restaurant. The content engine 150 can, in conjunction with third-party sources or services (e.g., the restaurant or a restaurant review service), generate content data 152 for presenting information related to the restaurant (e.g., reviews of the restaurant, menus offered by the restaurant etc.) on the user device 170. As another example, the content engine 150 can generate content data 152 for displaying information regarding points-of-interest (e.g., restaurants, bars, parks) within a certain distance (e.g., half a mile, 2 blocks, etc.) of the service location. For instance, the content engine 150 can generate content data 152 for displaying a list of recommended restaurants or bars in close proximity (e.g., within 2 blocks) of the service location on the user device 170.

In certain implementations, the content engine 150 can generate content data 152 based on a combination of one or more of the service progress information 141, service location information 142, and information relating to, stored in, or derived from the user's profile 148 (e.g., user information 146). For instance, the content engine 150 can determine, using both service location information 142 and user information 146 that the service location is the user's home address. In response, the content engine 150 can generate content data 152 for displaying user interface features that allow the user 174 to interact with or operate network-connected or smart appliances at home (e.g., air conditioner, heater, television, lights, etc.) and the like. Similarly, the content engine 150 can also generate content data 152 relating to a delivery service (e.g., food delivery service) that allows the user to order items (e.g., food) for delivery to the user's home. Using the service progress information 141, the generated content can provide further optimized user experience such that the delivery is scheduled for when or shortly after the user arrives at the service location. As another example, the network system can recognize, based on the user information 146 and the service location information 142, that a service request 171 from the user 174 is the first time the user 174 has requested service in a particular given region (e.g., from JFK Airport to New York City). In response, the network system can generate content to give the user 174 information regarding the given region (e.g., tourist information regarding New York City, etc.). In addition, the content engine 150 can determine a reading speed of the user based on user information 146 (e.g., based on the user's 174 historical reading statistics stored in the user profile 148), to select content that is appropriate based on the service progress information 141. For example, for a user determined based on user information 146 to be a fast reader, the content engine 150 can select lengthier news articles for a given service duration than compared with another user determined to be a slow reader.

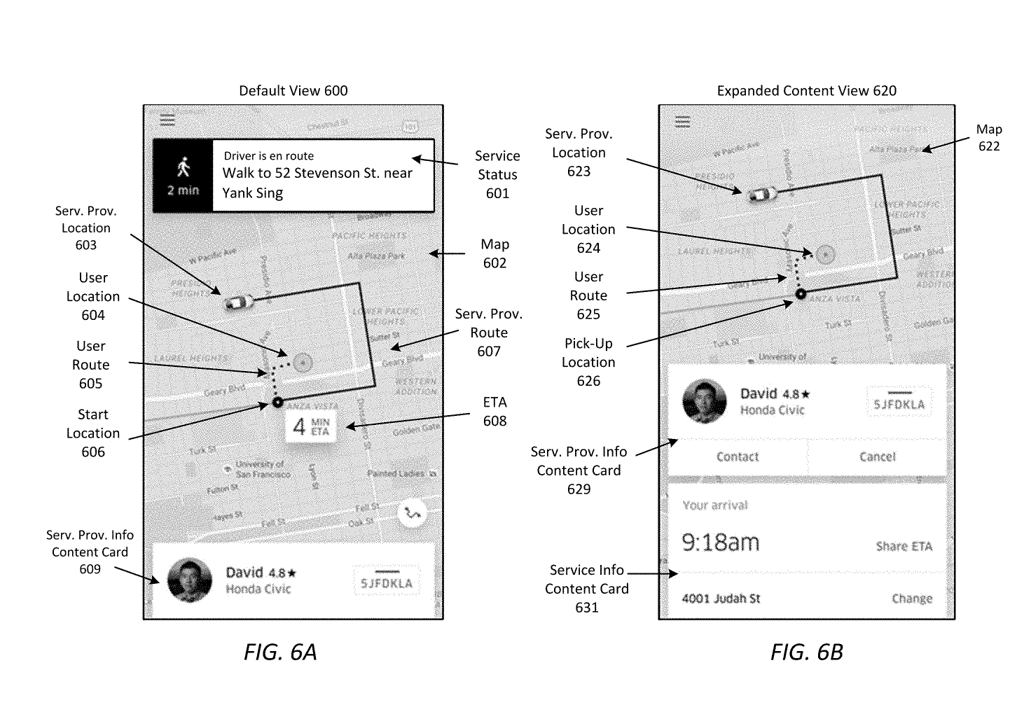

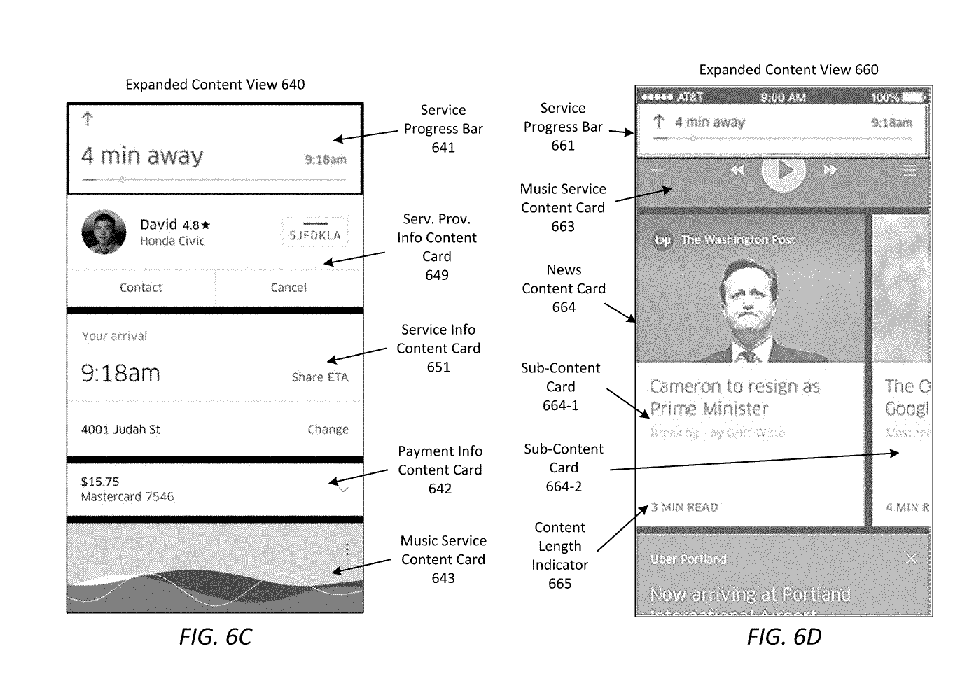

In certain implementations, the content engine 150 can receive user application status 177 and user inputs 179 from the user device interface 125. The user application status 177 can indicate a status of the user application, including, for example, that the user 174 is viewing or interacting with the user application 175 home screen. In this manner, the content engine 150 can generate content data 152 based on which aspect of the user application 175 the user is viewing or interacting with. For instance, certain content (e.g., announcements regarding the on-demand network service) can be displayed on the home screen of the user application 175 but not while the user is inputting a service location in the user application 175. User inputs 179 can correspond to a touch input (e.g., a downward swipe gesture, a tap input), a click, a keyboard or typing input, and the like. The user application 175 can pivot between various display modes or configurations, such as described with respect to FIGS. 6A through 6D, based on the user inputs 179.

According to embodiments, the network system 100 can include a third party interface 120 to communicate with third party service 155 to receive third party data 122, which can correspond to data pertaining to content from the third party services 155 for presentation on the user devices 170. Third party services 155 can include, for example, audio/video streaming services (e.g., a music streaming service or a video streaming service), news services, smart-home or connected-home services (e.g., services that allow users to control network-connected appliances), food delivery services, and any other service or data source that can provide content to the user 174 via the user application 175 user interface. The third party interface 120 also submit requests and data to the third party services 155 to, for example, select appropriate third party data 122 (e.g., via content selection 154) or submit user input in interacting with the 3rd party content presented on the user device (e.g., a user input to fast forward for a music streaming service). The content engine 150 can generate content selection 154 to interact with the third party service 155 to select content that is customized for each of the users in the manners described herein (e.g., based on service progress information 141, user information 146, user application status 177, or some combination thereof). In addition to or as an alternative, the third party interface 120 can communicate with a third party application executing on the user device 170 to receive third party data 122.

Methodology

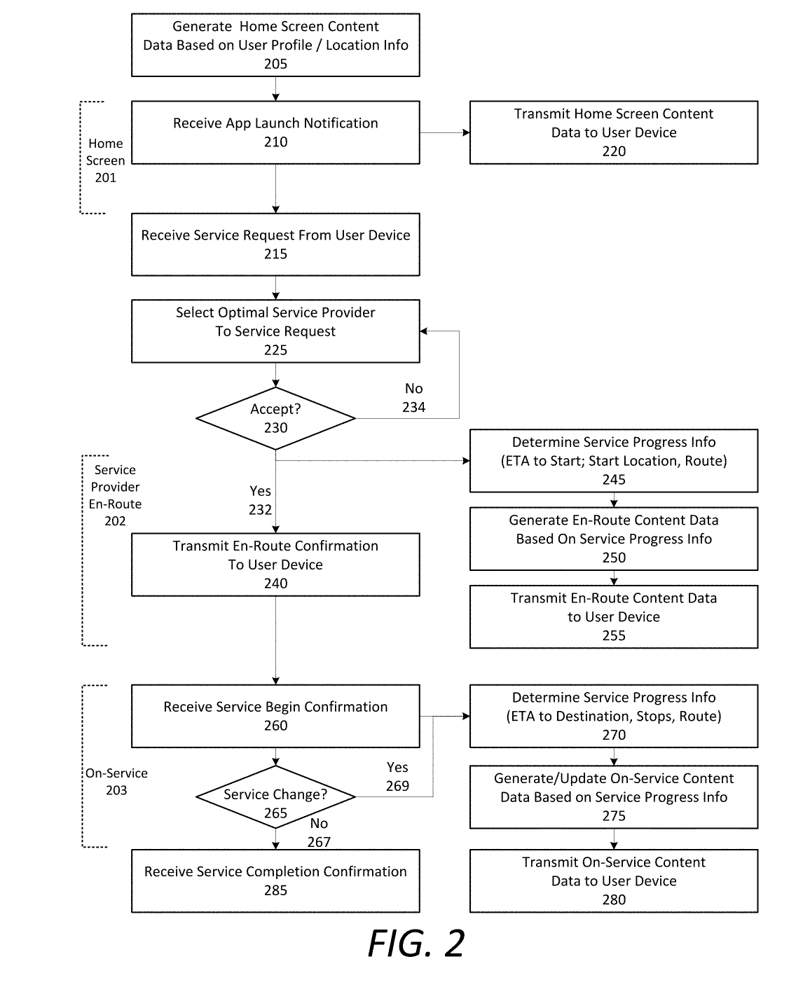

FIG. 2 is a flow chart describing an example method of generating customized user content for display on a user device, according to examples described herein. In the below discussion of FIG. 2, reference may be made to features and examples as shown and described with respect to FIG. 1. Furthermore, the process described with respect to FIG. 2 may be performed by an example network system 100 having a content engine 150 as shown and described with respect to FIG. 1. Referring to FIG. 2, network system 100 generates home screen content data based on user profile information and/or location information (205). Home screen content data can be used to display user interface features on a home screen 201 (e.g., default screen upon opening) of user application 175 running on the user devices 170. Based on each user's profile information and/or real-time location information, individualized and customized home screen content data can be generated. In this manner, for example, specific promotions related to the on-demand network service can be targeted towards individual users based on each user's profile information and the real-time location information. For instance, a user who has not used the on-demand network service within the past thirty days can be offered promotions or discounts to encourage the user's use of the service.

In the examples described herein, home screen content data can be generated prior to the specific user's opening of the user application 175 on the user device 170. The home screen content data can be cached in memory or one or more databases (e.g., database 145) in the network system 100 such that the home screen content data can be readily transmitted to the user device 170 when needed. In other examples, the home screen content data can be cached or stored on the user device 170.

The network system 100 receives application launch notification (210). The application launch notification can be transmitted as user application status 177 of FIG. 1 and notifies the network system 100 that a specific user has opened the user application 175 on the user device 170. In response to receiving the application launch notification at 210, the network system 100 can transmit generated home screen content data to the user device 170 (220). In the aforementioned examples where the home screen content is cached on the user devices 170, step 220 can occur prior to step 210. According to an alternative example, the network system 100 can receive the application launch notification, and in response, generate the home screen content data and transmit the home screen content data to the user device 170.

The network system 100 receives service request (e.g., service request 171) from the user device 170 (215). In response, the network system 100 selects an optimal service provider from a pool of service providers to service the request (225). This step can result in the transmission of an invitation 132 to the optimal service provider 189. At 230, the service provider can either accept (232) or deny (234) the invitation. If the service provider denies the invitation (234), the network system 100 selects another optimal service provider to service the request (225).

If the service provider accepts the invitation (232), the network system 100 transmits an en-route confirmation (e.g., confirmation 134) to the user device 170 (240) to indicate to the user device 170 that the selected service provider 189 is en-route to rendezvous with the user 174. The user application 175 can display a service provider en-route screen or interface 202 to indicate to the user that the service provider has been selected for the user and that the service provider is en-route.

The network system 100 can determine or estimate service progress information, including, for example, ETA to the start location, and one or more routes (e.g., for the service provider and/or the user) to the start location (245). In some examples, the start location can be entered or selected by the requesting user 174 or determined based on the location of the requesting user 174 (e.g., based on real-time information received from the user device 170). In certain implementations, the network system 100 can determine the start location based on map data 137 and other real-time information such as service provider location 113 and user location 173. For example, the start location can be determined to minimize the detours or deviations from an existing route by the selected service provider 189. In other examples, the start location can be determined to minimize the estimated time for the selected service provider 189 and/or requesting user 174 to arrive at the start location. Also as part of step 245, the system can determine a route for the user to travel to (e.g., by walking) the start location.

Based on the service progress information determined at 245, the network system 100 can generate en-route content data (250). The user device 170 can use the en-route content data to display one or more user interface features in the user application 175 during the time the selected service provider 189 is en-route to rendezvous with the user 174. En-route content data can include data to display a content card containing information regarding the selected service provider. In certain implementations, the en-route content data can be generated by selecting content of appropriate length (e.g., able to be viewed or consumed by the user before the assigned service provider arrives at the start location). In addition, the en-route content data can include data for displaying a route (e.g., displayed on a map or as a list of directions) for the user to travel to the start location. The network system 100 transmits the en-route content to the user device 170 (255).

In the examples described herein, the network system 100 system receives rendezvous confirmation indicating that the requesting user 174 has rendezvoused with the selected service provider 189 (260). This rendezvous confirmation can be received by the network system 100 from the user device 170 and/or the provider device 180. In other examples, the rendezvous confirmation can be generated by the network system 100 based on the service provider location 113 and the user location 173. The user application 175 can display an on-service screen or interface 203 to indicate to the user that the requested service has started for the user.

In various implementations, the network system 100 determines or estimates service progress information (e.g., service progress information 141 of FIG. 1) that can include information such as ETA to the service location, information relating to intermediate locations, and route to the service location in response to receiving the rendezvous confirmation (260). The network system 100 can generate or update on-service content data for presentation on the user device 170 while the user is en-route to the service location based on the determined service progress information (275). For instance, the on-service content data can be generated based on an ETA to the service location. In addition to or as an alternative, the on-service content data can be generated based on information pertaining to the service location and information pertaining to the requesting user 174. At 280, the network system 100 transmits data corresponding to the generated on-service content to the requesting user device 170 (280).

At 265, the network system 100 monitors for a service change after the requesting user 174 has rendezvoused with the selected service provider 189. A service change can occur when the requesting user 174 modifies the service location. It can also occur in the event that the network system 100 determines an intermediate location or an alternate route to the service location (e.g., based on traffic information). In the event of detecting a service change (265), the network system 100 proceeds to steps 270, 275, and 280 to determine updated service progress information and update on-service content based on the updated service progress information. If the network system 100 does not detect a service change (267), the system will receive a service completion confirmation when the service is completed (e.g., user 174 arrives at the service location) (285).

The examples described herein allow for the generation of content data customized for different phases of the user's experience with the on-demand network service. For instance, content data can be varied based on whether the user is viewing the home screen before submitting a service request (e.g., home screen content data), waiting for the service provider (e.g., en-route content data), or after rendezvousing with the service provider (e.g., on-service content data). In addition, according to embodiments, the content data can be generated based on service progress information determined at various stages of the user's interactions with the network service, information pertaining to the service location, and the user profile.

User Device

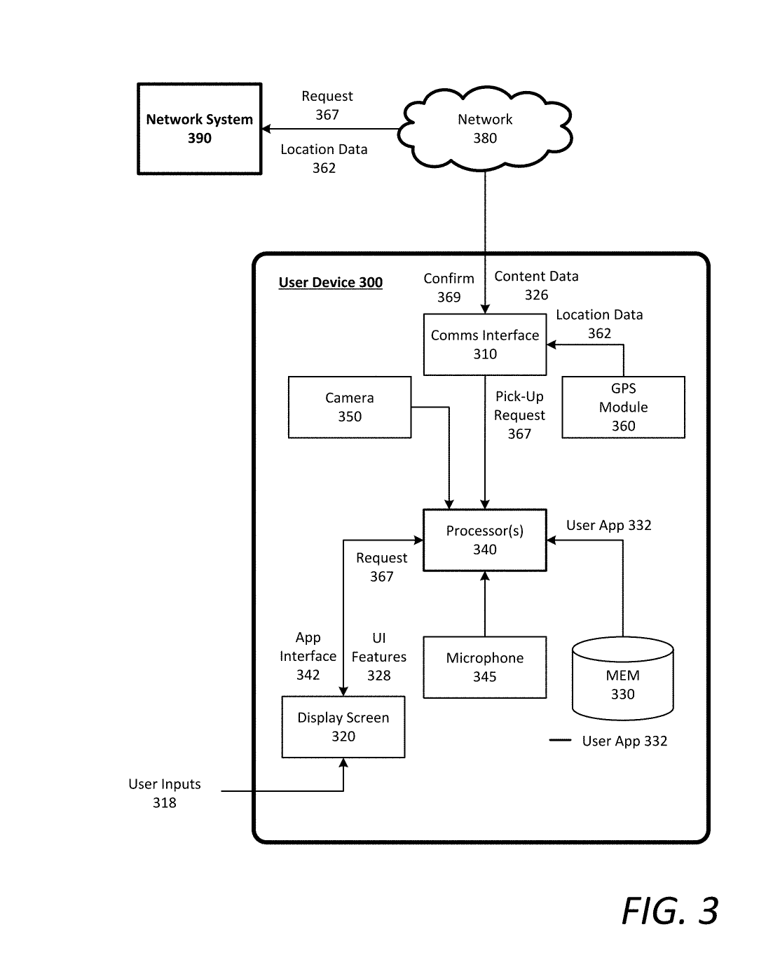

FIG. 3 is a block diagram illustrating an example user device executing a designated user application for a network service, as described herein. In many implementations, the user device 300 can comprise a mobile computing device, such as a smartphone, tablet computer, laptop computer, VR or AR headset device, and the like. As such, the user device 300 can include typical telephony features such as a microphone 345, a camera 350, and a communication interface 310 to communicate with external entities using any number of wireless communication protocols. In certain aspects, the user device 300 can store a designated application (e.g., a user app 332) in a local memory 330. In many aspects, the user device 300 further store information corresponding to a contacts list 334, and calendar appointments 336 in the local memory 330. In variations, the memory 330 can store additional applications executable by one or more processors 340 of the user device 300, enabling access and interaction with one or more host servers over one or more networks 380.

In response to a user input 318, the user app 332 can be executed by a processor 340, which can cause an app interface 342 to be generated on a display screen 320 of the user device 300. The app interface 342 can enable the user to, for example, check current price levels and availability for the network service. In various implementations, the app interface 342 can further enable the user to select from multiple ride service types, such as a carpooling service type, a regular ride-sharing service type, a professional ride service type, a van transport service type, a luxurious ride service type, and the like.

The user can generate a service request 367 via user inputs 318 provided on the app interface 342. For example, the user can select a start location, view the various service types and estimated pricing, and select a particular service to an inputted service location. In many examples, the user can input the service location prior to rendezvousing with the service provider. As provided herein, the user application 332 can further enable a communication link with a network system 390 over the network 380, such as the network system 100 as shown and described with respect to FIG. 1. The processor 340 can generate user interface features 328 (e.g., map, service progress bar, content cards, etc.) using content data 326 received from the network system 390 over network 380. Furthermore, as discussed herein, the user application 332 can enable the network system 390 to cause the generated user interface 328 to be displayed on the application interface 342.

The processor 340 can transmit the service requests 367 via a communications interface 310 to the backend network system 390 over a network 380. In response, the user device 300 can receive a confirmation 369 from the network system 390 indicating the selected service provider that will service the service request 367 and rendezvous with the user at the start location. In various examples, the user device 300 can further include a GPS module 360, which can provide location data 362 indicating the current location of the requesting user to the network system 390 to, for example, establish the start location and/or select an optimal service provider or autonomous vehicle to service the service request 367.

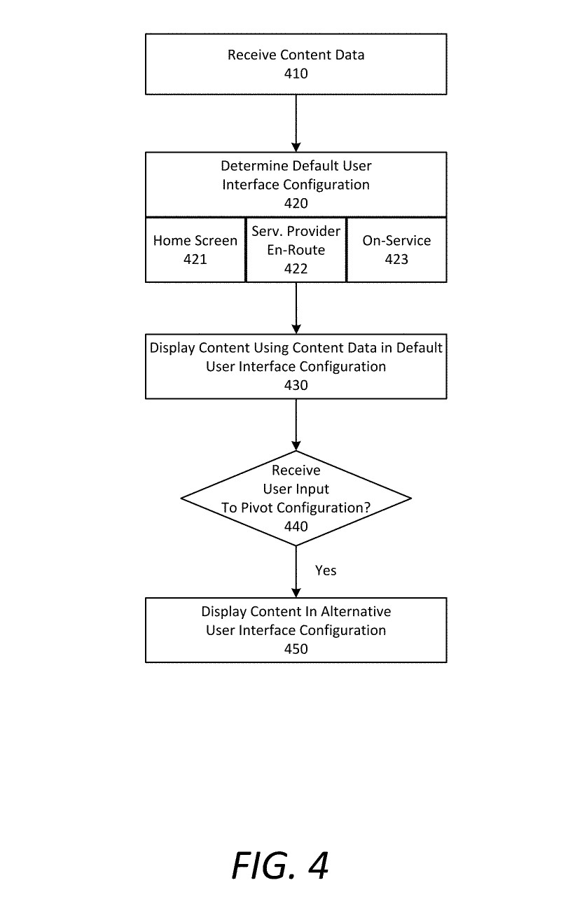

FIG. 4 is a flow chart describing an example method of displaying customized user content on a user device, according to examples described herein. In the below discussion of FIG. 4, reference may be made to features and examples as shown and described with respect to FIGS. 1 through 3. Furthermore, the process described with respect to FIG. 4 may be performed by an example user device 300 such as the one illustrated in FIG. 3. Referring to FIG. 4, the user device 170 receives content data 152 from the network system 100 (410). In various implementations, the user device 170 may continuously receive updated content data 152 from the network system 100 before, during, or after a service facilitated by the network system 100. In certain examples, the user device 170 may store or cache the received content data 152.

In various aspects, the user device 170 determines default user interface configuration (420). The user device 170 can make the determination at step 420 based on service progress information 141 received from the network system 100. The default user interface configuration can be a default layout or arrangement of features within the user interface of the user application 175 executing on the user device 170. The default user interface configuration can be different depending on the current service status. For instance, when the user 174 first opens the user application 175 to arrive at the home screen (421), a first default user interface configuration may be used. In various examples, the first default user interface configuration can include features such as a map to allow the user to view the surrounding area, a location entry feature to allow the user to enter a service location and/or a start location, and a service selection feature to allow the user to select a service type (e.g., a professional car service, a premium or luxury car service, a ride-pool or carpool service, a large vehicle request etc.). In some implementations, the first default user interface configuration can also include one or more service accelerators, which are selectable features on the client application that, when selected by the user, automatically associates a service request with a set of parameters or preconfigured settings based on contextual information (or a set of criteria). For instance, a “home” service accelerator can be displayed on the home screen of the user application at times (e.g., 5-7:30 pm on every weekday) the user routinely utilizes the network service to request a service to a service location corresponding to the user's home. In the first default user interface configuration, features are arranged in a manner to allow the user to easily submit a request a service request. For instance, the location entry feature can be prominently displayed on the user device. According to embodiments described herein, the user device can monitor for user inputs to pivot from the first default user interface configuration to other configurations while displaying the home interface 201.

A second default user interface configuration may be used when the assigned service provider 189 is en-route to pick up the user 174 (422). In certain implementations, the second default user interface configuration can include a map to display the start location, locations of the user and service provider (e.g., determined by the network system 100 based on real-time location data received from the user and provider devices) optimal routes (as determined by the network system 100 based on mapping data, real-time location data, and traffic information) for the user and service provider to travel to the start location, and estimated times of arrival of the user and service provider to the start location. In the second default user interface configuration, features can be arranged in manner to allow the user to easily view the start location and the route for the user to travel to the start location. For instance, the map and the user route to the start location can be prominently displayed on the user device. Furthermore, in the second default user interface configuration, one or more features (e.g., a content card) showing information regarding the assigned service provider 189 can be displayed. Such information can allow the user to identify the assigned service provider 189 and the vehicle of the assigned service provider 189. An example second default user interface configuration can be default view 600 of FIG. 6. According to embodiments described herein, the user device can monitor for user inputs to pivot from the second default user interface configuration to other configurations while displaying the service provider en-route screen 202. For instance, the user device can pivot to other configurations such as expanded content views 620, 640, and 660 based on user input (e.g., a swipe or scroll input). In certain examples such as expanded content views 640 and 660, the map 602 of the default view can be replaced with service progress bars 641 and 661 such that additional content can be displayed. For instance, once the user has arrived at the start location, the user may wish to view news articles rather than the map displaying a route to the start location. Thus, the user can cause (e.g., via one or more inputs such as a swipe or scroll input) the user application to display additional content such as news articles in expanded content view 660.

Furthermore, a third default user interface configuration may be used when the user 174 is on-service (e.g., after the user 174 has been picked up by the assigned service provider 189) (423). In some examples, the third default user interface configuration can include a map showing the current service provider/user location, the route to the service location, an estimated time of arrival at the service location, and intermediate locations en-route to the service location (if any). In other examples, the third default user interface configuration can include a service progress bar illustrating the service progress in a one-dimensional manner, including a current progress of the service (e.g., time elapsed as compared to the total service time, distance covered as compared to the total distance to the service location, etc.), an estimated time of arrival at the service location, and information regarding any intermediate locations en-route to the service location (if any). In various implementations, the third default user interface configuration can include content cards displaying content that the user can view or select to view on the on-service screen 203. According to embodiments described herein, the user device can monitor for user inputs to pivot from the third default user interface configuration to other configurations while displaying the on-service screen 203.

According to embodiments, the user device 170 displays content using content data 152 received from the network system 100 in the default user interface configuration determined in step 420 (430). Furthermore, the user device 170 may monitor for user input to pivot the user interface from the default user interface configuration to another configuration (440). Such user input can include touch inputs received on a touchscreen of the user device 170, such as a swipe gesture or a tap input. The user device 170 can pivot to another configuration by re-arranging the user interface features displayed in the user application 175. For instance, a map can be minimized and instead a service progress bar can be displayed. If the user device 170 detects or receives user input to pivot the user interface configuration, the user device 170 displays content in one or more alternative user interface configurations (450).

User Interface

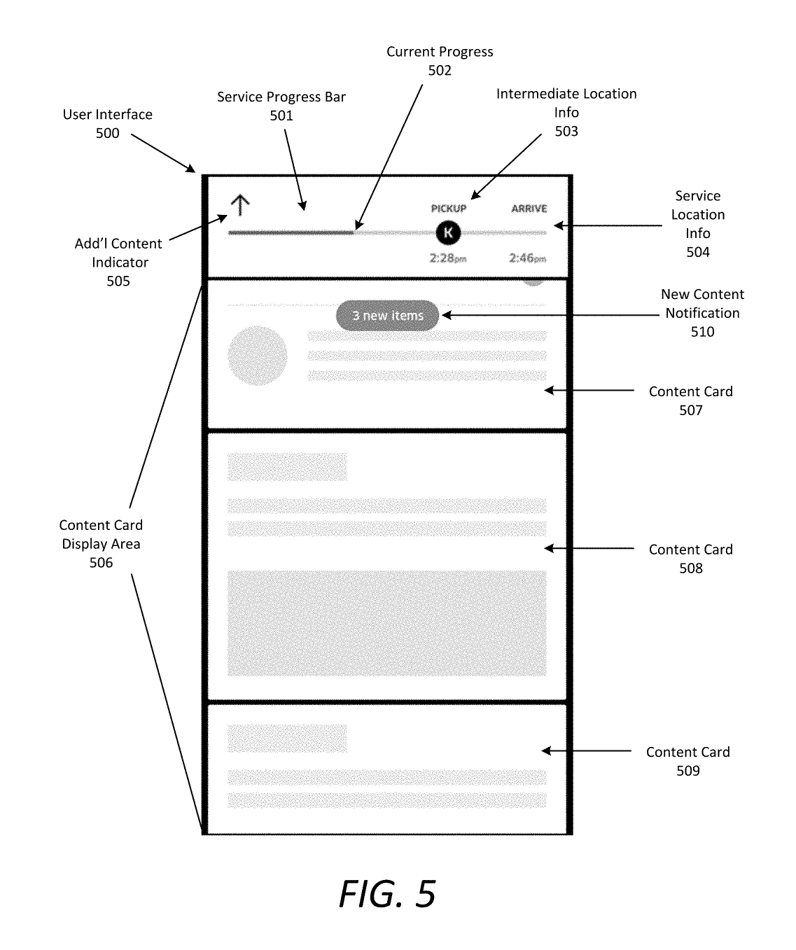

FIG. 5 is a screenshot illustrating an example user interface on a user device, according to examples described herein. The user interface 500 of the user application executing on a user device includes service progress bar 501 and a content card display area 506. The service progress bar 501 can be presented by the user device using content data received from the network system (e.g., content data 152). The received content data can include service progress and/or service location information (e.g., service progress information 141, service location information 142) to display the service progress bar 501. The service progress bar 501 includes an indication of the current progress 502. As illustrated in FIG. 5, the current progress 502 can be shown as a portion of the service progress bar 501 to indicate the current progress of the service towards the service location. The portion of the service progress bar 501 occupied by the current progress 502 can be indicative of a distance or a time duration (or a combination thereof) until the completion of the service.

In various aspects, the service progress bar 501 can also include an indicator, intermediate location info 503, to indicate an intermediate location during the service. Intermediate locations during a service can be made to, for example, rendezvous with or complete a service for a user (e.g., a companion of the requesting user or a service-pooling or service-sharing user). The intermediate location info 503 can be positioned along the service progress bar 501 to indicate a distance to or a time duration until arrival at the intermediate location. The intermediate location info 503 can also include textual information to indicate whether a passenger is to be picked up (e.g., “Pickup”) or dropped off (e.g., “Drop Off”). In addition, the intermediate location info 503 can further include an estimated time of arrival at the intermediate location (e.g., “2:28 pm”). As an alternative or in addition to, the intermediate location info 503 can include an indication of an estimated time duration until arrival at the intermediate location (e.g., “12 minutes”).

In some examples, the service progress bar 501 can also include service location info 504 to indicate information related to the service location for the user viewing the user interface 500. The service location info 504 can be positioned at the end of the service progress bar as illustrated in FIG. 5. The service location info 504 can also include an estimated time of arrival at the service location (e.g., “2:46 pm”). As an alternative or in addition to, the service location info 504 can include an indication of an estimated time duration until arrival at the intermediate location (e.g., “30 minutes”).

According to embodiments, two service-pooling or service-sharing users can be serviced by the same service provider. The two service-sharing users can receive different content data to display service progress bars 501 on the users' respective user devices. For instance, a first of the two users can be dropped off first. The first user may be presented, on the first user's device, with a service progress bar 501 with the service location info 504 indicating the time to the first user's service location as “3 pm.” At the same time, the second of the two users can be presented, on the second user's device, with a service progress bar 501 including intermediate info 503 indicating the estimated time to arrive an intermediate location of the second user as “3 pm.” The second user can also be presented with service location info 504 indicating an estimated time to arrive at the service of the second user.

In certain implementations, user interface 500 can also include an additional content indicator 505 to indicate that the user can view additional content by scrolling up or down within user interface of the user application. For instance, in response to a scroll up or down input from the user, the user device can pivot from displaying the service progress bar 501 to displaying a two-dimensional map showing additional information regarding the service, such as the route taken, nearby areas, street names, etc.

In some examples, the user interface 500 further includes a content card display area 506 that includes a plurality of content cards 507-509. Each of the content cards 507-509 can display content regarding a respective subject and each can include text, hyperlinks, images, videos and/or interactive features such as buttons. The content cards 507-509 can be interacted with by the user, including being selected and/or dismissed. For instance, a user can select a content card by tapping or clicking on the area within the content card. The user application can expand the content card in response to the user's selection of the content card such that additional content regarding the subject of the content card is displayed within the content card display area 506. In certain instances, a content card may include a title and a synopsis of the content regarding a subject and expanding the content card can have the effect of displaying additional content regarding the subject in the content card display area 506. As an example, if the user selects content card 507, additional content pertaining to the subject of content card 507 can be displayed in the content card display area 506. The other content cards 508-509 can be minimized while content card 507 is expanded.

In certain implementations, one or more of the content card 507-509 can be dismissed by the user. For instance, the user can swipe right or left within a content card to dismiss it. As another example, the user can select a feature (e.g., a Close button) within the content card to dismiss it. In certain examples, the network system can keep a historical record of the content cards the user selects and dismisses as part of the information stored in the user's user profile. The network system can utilize such information to generate content data that suits the user's tastes and preferences. For instance, the network system can keep records that the user frequently selects content cards pertaining to football scores and can generate content data based on such information.

According to embodiments, a content card may include interactive features (e.g., soft buttons or selectable features) with which the user can interact within the content card. For instance, a content card pertaining to a music streaming service may include an interactive button to play music and another interactive button to fast forward. The user can select one or more of these buttons to interact with the music streaming service without needing to select or expand the content card. In certain implementations, the user interface 500 contains a new content notification 505 that indicates new items or content cards not yet viewed by the user.

FIG. 6A is a screenshot illustrating a default view 600 of an example user interface, according to examples described herein. According to embodiments, the user device determines that the default configuration of the user interface of the user application should be default view 600 in response to determining that a service provider selected by the network system 100 to service a service request is en-route to pick up the user at a start location (e.g., using service progress information 141 received from the network system 100). The start location may be entered or selected by the user or may be determined by the network system 100. Other default configurations may be used in response to determining, for example, that the user has been picked up by the selected service provider.

Default view 600 includes a service status 601 that displays a summary of the current status of the service. The service status 601 can indicate an estimated time duration for the user to travel to the start location. The service status 601 can also include text to indicate that the service provider is en-route to the start location (e.g., “Service provider is en route”). According to embodiments, the service status 601 can also include directions for the user to travel to the start location.

In various examples, the default view 600 includes a map 602 showing features including a service provider location 603, a user location 604, a user route 605, a start location 606, and a service provider route 607. These features may be displayed as overlays on the map 602. The service provider location 603 illustrates the current, real-time position of the service provider assigned by the network system 100 to service the pickup request from the user. The service provider location 603 can be displayed using data received by the user device from the network system 100 (e.g., content data 152). The content data 152 corresponding to the service provider location 603 can be determined by the network system 100 using service provider location data (e.g., service provider location 113) received from the provider device 180. The user location 604 illustrates the current, real-time position of the user. In some examples, the user location 604 can be displayed using data received by the user device from the network system 100 (e.g., content data 152). The content data 152 corresponding to the user location 604 can be determined by the network system 100 using user location data (e.g., user location 173) received from the user device. In other examples, the user device can display user location 604 using data generated by components of the user device (e.g., GPS module 360).

The user route 605 illustrates an optimal route for the user to travel from the user location 604 to the start location 606. The user route 605 can be displayed using data generated by the network system 100. In other examples, the user device can determine the optimal route and display the user route 605. The service provider route 607 illustrates an optimal route for the service provider to travel from the service provider location 603 to the start location 606. The service provider route 607 can be displayed by the user device using data generated by the network system 100. The default view 600 can also include an ETA 608 that shows the estimated time of arrival of the service provider at the start location 606. In some examples, the default view 600 also includes a service provider info content card 609 that displays, for example, the assigned service provider's name, rating, car model, and license plate number. Using the information displayed in the service provider info content card 609, the user can identify the assigned service provider as the service provider arrives at the start location 606.

In various aspects, the user device can pivot the user interface of the user application from the default view 600 such that additional content (e.g., content cards) can be displayed within the user interface. The pivot of the user interface can be performed in response to input from the user. Such input can include touch input on a touchscreen of the user device (e.g., a downward swipe gesture, a tap gesture, etc.). In response to such gestures, the user device can pivot the user interface from the default view 600 to an expanded content view.

FIG. 6B is a screenshot illustrating an expanded content view 620 of an example user interface of the user application, according to examples described herein. According to embodiments, the user device can pivot from the default view 600 to arrive at the expanded content view 620 in response to user input (e.g., a swipe or tap gesture). In some examples, the user device can display one or more animations to transition from default view 600 and expanded content view 620. Such animations can include ones showing one or more content cards sliding into position at 629 and 631.

In the examples described herein, the expanded content view 620 includes a map 622, a service provider location 623, a user location 624, a user route 625, a start location 626, a service provider info content card 629, and a service info content card 631. In comparison to the default view 600, the expanded content view 620 displays additional content cards. For instance, the service provider info content card 629 is maximized in comparison to service provider info content card 609. In addition, the service info content card 631, which shows an estimated time of arrival, a service location address, and user interface features to share the ETA and change the service location address, is displayed. According to embodiments, the user device can pivot from the expanded view 620 to other user interface configurations in response to user input.

FIG. 6C is a screenshot illustrating another expanded content view 640 of an example user interface of the user application, according to examples described herein. In various implementations, the user device can pivot from expanded content view 620 to arrive at expanded content view 640 in response to user input such as a downward swipe gesture or a tap gesture. In some examples, the user device can display one or more animations to transition from expanded content view 620 to expanded content view 640. Such animations can include ones showing the map 622 being replaced by one or more content cards (e.g. 642, 643, 649, and 651) and the service progress bar 641. For example, the user can tap and drag (swipe input) the content card 631 (or another content card), as illustrated in FIG. 6B, in an upward direction to view additional content. As the drag input is being made, the viewable map 622 can decrease in size and the service progress bar 641 can dynamically be created and displayed as illustrated in FIG. 6C.

According to embodiments, the expanded content view 640 includes a service progress bar 641, a service provider info content card 649, a service info content card 651, a payment info content card 642, and a music service content card 643. Payment info content card 642 displays a method of payment a fare for the service arranged by the network system 100. The music service content card 643 includes content to allow the user to interact with a third party music streaming service. For instance, the music service content card 643 can include features to play, fast forward, and rewind music. In comparison to the expanded content view 620, the expanded content view 640 replaces the map 622 with the service progress bar 641. Furthermore, additional content cards (e.g., content cards 642 and 643) can be displayed. According to embodiments, the user device can pivot from the expanded view 640 to other user interface configurations in response to user input.

FIG. 6D is a screenshot illustrating yet another expanded content view 660 of an example user interface of the user application, according to examples described herein. In various implementations, the user device can pivot from expanded content view 640 to arrive at expanded content view 660 in response to user input such as a downward swipe gesture or a tap gesture.

In certain implementations, the expanded content view 660 includes a service progress bar 661, a music service content card 663, and a news content card 664. According to various examples, the news content card 664 can include multiple sub-content cards such as sub-content cards 664-1 and 664-2. Each of the sub-content cards 664-1 and 664-2 can display a title, a synopsis, and/or a figure for a respective news story. Each sub-content card can be individually dismissed by the user using one or more gestures. Furthermore, the user can use a sideways scroll gesture to scroll through the sub-content cards within the news content card 664.

In various aspects, sub-content card 664-1 includes a content length indicator 665. The content length indicator 665 can represent an estimated amount of time for the user to read or consume the content within the sub-content card 664-1. The network system 100 can, for example, estimate the amount of time for the user to read or consume a content card or sub-content card based on an amount of content (e.g., number of words or characters) in the content card or sub-content card once they are expanded or selected. In certain implementations, the network system 100 can keep historical records pertaining to user's reading speed (e.g., stored in user profile 148) and use such historical records to estimate the amount of time for the user to read or consume content. The network system 100 can select content for the generation of content data based on a comparison between the estimated amount of time for the user to read or consume the content and an ETA to the service location or an ETA for the service provider to arrive at the start location. For instance, if the ETA to service location is five minutes, the network system 100 can select news articles from a third party news service that are estimated to be read by the user in less than five minutes.

In comparison to the expanded content view 640, the expanded content view 660 can display additional content by minimizing the service progress bar 641. In various implementations, the user device can pivot the user interface to other configurations from the expanded content view 660 in response to user input.

Provider Device

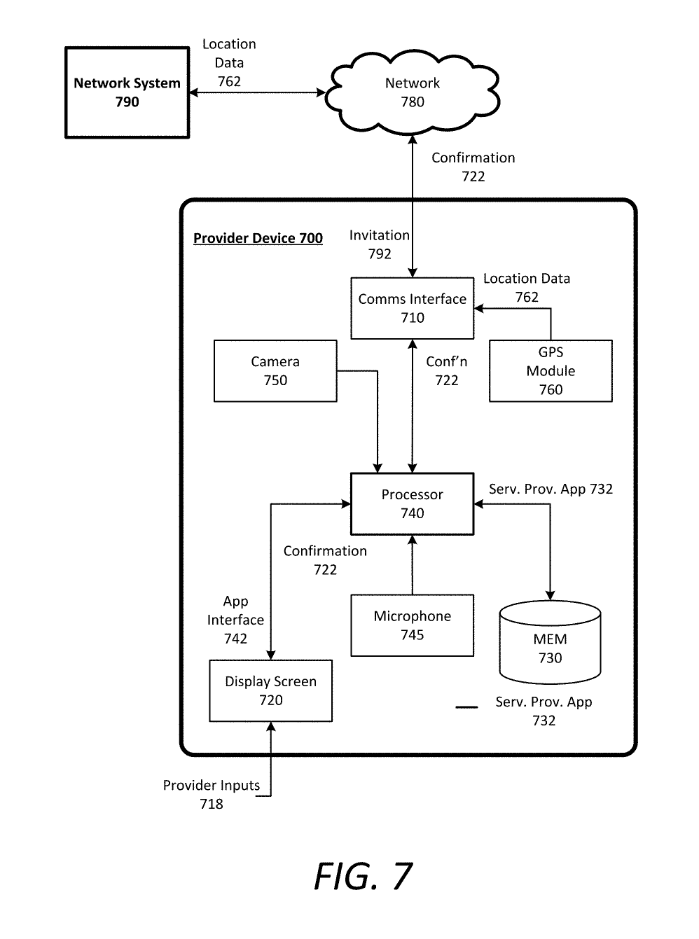

FIG. 7 is a block diagram illustrating an example provider device executing a designated service provider application for a network service, as described herein. In many implementations, the provider device 700 can comprise a mobile computing device, such as a smartphone, tablet computer, laptop computer, VR or AR headset device, and the like. As such, the provider device 700 can include typical telephony features such as a microphone 745, a camera 750, and a communication interface 710 to communicate with external entities using any number of wireless communication protocols. The provider device 700 can store a designated application (e.g., a service provider app 732) in a local memory 730. In response to a provider input 718, the service provider app 732 can be executed by a processor 740, which can cause an app interface 742 to be generated on a display screen 720 of the provider device 700. The app interface 742 can enable the service provider to, for example, accept or reject invitations 792 in order to service requests throughout a given region.

In various examples, the provider device 700 can include a GPS module 760, which can provide location data 762 indicating the current location of the service provider to the network system 790 over a network 780. Thus, the network system 790 can utilize the current location 762 of the service provider to determine whether the service provider is optimally located to service a particular service request. If the service provider is optimal to service the service request, the network system 790 can transmit an invitation 792 to the provider device 700 over the network 780. The invitation 792 can be displayed on the app interface 742, and can be accepted or declined by the service provider. If the service provider accepts the invitation 792, then the service provider can provide a user input 718 on the displayed app interface 742 to provide a confirmation 722 to the network system 790 indicating that the service provider will rendezvous with the requesting user at the start location to service the service request.

Hardware Diagram

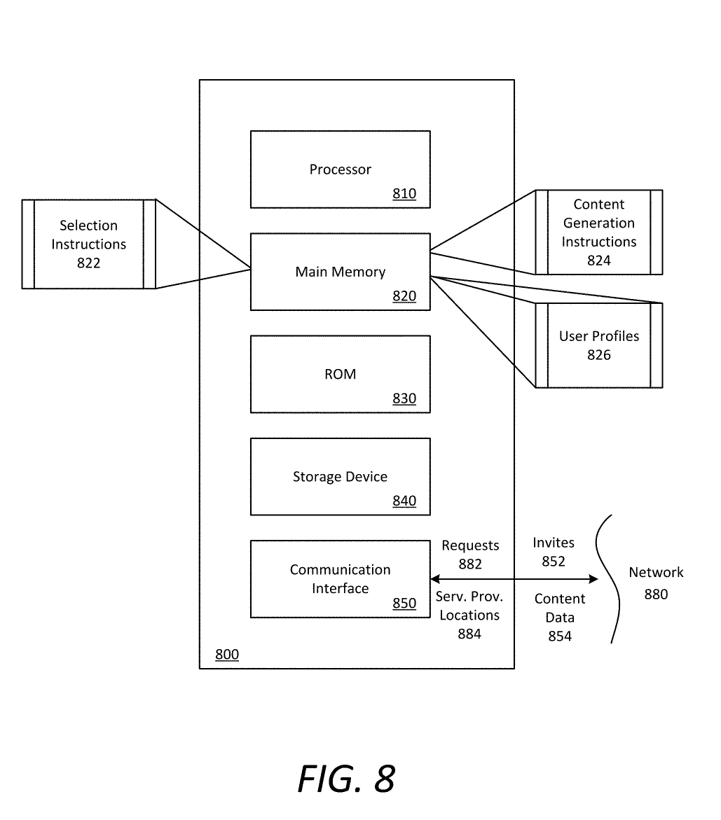

FIG. 8 is a block diagram that illustrates a computer system upon which examples described herein may be implemented. A computer system 800 can be implemented on, for example, a server or combination of servers. For example, the computer system 800 may be implemented as part of a network service for providing network services. In the context of FIG. 1, the network system 800 may be implemented using a computer system 800 such as described by FIG. 8. The network system 100 may also be implemented using a combination of multiple computer systems as described in connection with FIG. 8.

In one implementation, the computer system 800 includes processing resources 810, a main memory 820, a read-only memory (ROM) 830, a storage device 840, and a communication interface 850. The computer system 800 includes at least one processor 810 for processing information stored in the main memory 820, such as provided by a random access memory (RAM) or other dynamic storage device, for storing information and instructions which are executable by the processor 810. The main memory 820 also may be used for storing temporary variables or other intermediate information during execution of instructions to be executed by the processor 810. The computer system 800 may also include the ROM 830 or other static storage device for storing static information and instructions for the processor 810. A storage device 840, such as a magnetic disk or optical disk, is provided for storing information and instructions.

The communication interface 850 enables the computer system 800 to communicate with one or more networks 880 (e.g., cellular network) through use of the network link (wireless or wired). Using the network link, the computer system 800 can communicate with one or more computing devices, one or more servers, and/or one or more self-driving vehicles. In accordance with examples, the computer system 800 receives service requests 882 from mobile computing devices of individual users. The executable instructions stored in the memory 830 can include selection instructions 822, which the processor 810 executes to select an optimal service provider to service the service request 882. In doing so, the computer system can receive service provider locations 884 of service providers operating throughout the given region, and the processor can execute the selection instructions 822 to select an optimal service provider from a set of available service providers, and transmit a invitation 852 to enable the service provider to accept or decline the invitation.

The executable instructions stored in the memory 820 can also include content generation instructions 824, which enable the computer system 800 to access user profiles 826 and other user information in order to select and/or generate content data 854 for display on the user devices. As described throughout, content data 854 can be generated based on information pertaining to the state of the service request (e.g., service progress info or service location info). By way of example, the instructions and data stored in the memory 820 can be executed by the processor 810 to implement an example network system 100 of FIG. 1. In performing the operations, the processor can generate content data 854 to be transmitted to the user devices over network 880. The processor 810 is configured with software and/or other logic to perform one or more processes, steps and other functions described with implementations, such as described by FIGS. 1 through 7, and elsewhere in the present application.

Examples described herein are related to the use of the computer system 800 for implementing the techniques described herein. According to one example, those techniques are performed by the computer system 800 in response to the processor 810 executing one or more sequences of one or more instructions contained in the main memory 820. Such instructions may be read into the main memory 820 from another machine-readable medium, such as the storage device 840. Execution of the sequences of instructions contained in the main memory 820 causes the processor 810 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A method of displaying content on a mobile computing device, comprising:
receiving, over one or more networks from a remote computing system, a set of service progress data corresponding to a transport service for a user of the mobile computing device;
presenting, on a display of the mobile computing device using at least a portion of the set of service progress data, a user interface in a first configuration that includes (i) a first section for displaying a map, and (ii) a second section for displaying information related to the transport service, including a first set of information pertaining to a service provider identified by the remote computing system;
detecting user input on the user interface while the user interface is presented in the first configuration; and
in response to detecting the user input while the user interface is presented in the first configuration, pivoting the user interface from the first configuration to a second configuration by expanding the second section for displaying information related to the transport service to replace at least a portion of the first section for displaying the map, wherein the expanded second section of the user interface displays the first set of information pertaining to the service provider identified by the remote computing system and service information of the transport service using at least a portion of the set of service progress data, wherein the service information is based, at least in part, on a service location of the transport service.

2. The method of claim 1, wherein the user interface in the first configuration further includes: (iii) a graphic feature corresponding a location of a vehicle for the transport service on the map, and (iv) a set of route lines corresponding to a route of travel of the vehicle on the map.

3. The method of claim 2, further comprising:
determining, using a location detection component of the mobile computing device, a current location of the mobile computing device; and
wherein the user interface in the first configuration includes a graphic indicator corresponding to the current location of the mobile computing device on the map.

4. The method of claim 1, wherein expanding the second section for displaying information related to the transport service to replace at least a portion of the first section for displaying the map includes displaying a progress bar that indicates current progress of the transport service in place of the map.

5. The method of claim 1, wherein the service location corresponds to a start location of the transport service, and wherein the service information of the transport service displayed in the expanded second section of the user interface includes an estimated time of arrival at the start location.

6. The method of claim 1, wherein the service location corresponds to a destination location of the transport service, and wherein the service information of the transport service displayed in the expanded second section of the user interface includes an estimated time of arrival at the destination location.

7. The method of claim 1, wherein the service information of the transport service displayed in the expanded second section of the user interface includes information relating to a payment method of the user for the transport service.

8. The method of claim 1, wherein the service information of the transport service displayed in the expanded second section of the user interface includes an address of a destination location of the transport service.

9. The method of claim 1, wherein the first set of information pertaining to the service provider identified by the remote computing system includes (i) a name of the service provider identified by the remote computing system, (ii) an image of the service provider, and (iii) a rating of the service provider.

10. The method of claim 1, wherein the first set of information pertaining to the service provider identified by the remote computing system includes (i) a license plate identifier of a vehicle of the service provider, and (ii) a model of the vehicle of the service provider.

11. The method of claim 1, further comprising presenting the user interface in the first configuration as a default configuration of the user interface based on the set of service progress data indicating that the service provider identified by the remote computing system is en-route to a start location of the transport service.

12. The method of claim 1, wherein the second configuration of the user interface further includes a user interface feature for modifying the service location of the transport service that is not included in the first configuration of the user interface.

13. The method of claim 1, wherein expanding the second section for displaying information related to the transport service to replace at least a portion of the first section for displaying the map includes displaying a transition animation showing the portion of the first section of the user interface being replaced by the expanded second section of the user interface.

14. The method of claim 1, further comprising:
while presenting the user interface in the second configuration, receiving a second user input; and
in response to receiving the second user input while the user interface is presented in the second configuration, pivoting the user interface from the second configuration back to the first configuration.

15. A mobile computing device, comprising:
one or more processors; and
one or more memory resources storing instructions that, when executed by the one or more processors of the mobile computing device, cause the mobile computing device to:
receive, over one or more networks from a remote computing system, a set of service progress data corresponding to a transport service for a user of the mobile computing device;
present, on a display of the mobile computing device using at least a portion of the set of service progress data, a user interface in a first configuration that includes (i) a first section for displaying a map, and (ii) a second section for displaying information related to the transport service, including a first set of information pertaining to a service provider identified by the remote computing system;
detect user input on the user interface while the user interface is presented in the first configuration; and
in response to detecting the user input while the user interface is presented in the first configuration, pivot the user interface from the first configuration to a second configuration by expanding the second section for displaying information related to the transport service to replace at least a portion of the first section for displaying the map, wherein the expanded second section of the user interface displays the first set of information pertaining to the service provider identified by the remote computing system and service information of the transport service using at least a portion of the set of service progress data, wherein the service information is based, at least in part, on a service location of the transport service.

16. The mobile computing device of claim 15, wherein the executed instructions further cause the mobile computing device to present the user interface in the first configuration as a default configuration of the user interface based on the set of service progress data indicating that the service provider identified by the remote computing system is en-route to a start location of the transport service.

17. The mobile computing device of claim 15, wherein the executed instructions further cause the mobile computing device to:
while presenting the user interface in the second configuration, receive a second user input; and
in response to receiving the second user input while the user interface is presented in the second configuration, pivot the user interface from the second configuration back to the first configuration.

18. A non-transitory computer-readable medium storing instructions that, when executed by one or more processors of a mobile computing device, cause the mobile computing device to:
receive, over one or more networks from a remote computing system, a set of service progress data corresponding to a transport service for a user of the mobile computing device;
present, on a display of the mobile computing device using at least a portion of the set of service progress data, a user interface in a first configuration that includes (i) a first section for displaying a map, and (ii) a second section for displaying information related to the transport service, including a first set of information pertaining to a service provider identified by the remote computing system;
detect user input on the user interface while the user interface is presented in the first configuration; and
in response to detecting the user input while the user interface is presented in the first configuration, pivot the user interface from the first configuration to a second configuration by expanding the second section for displaying information related to the transport service to replace at least a portion of the first section for displaying the map, wherein the expanded second section of the user interface displays the first set of information pertaining to the service provider identified by the remote computing system and service information of the transport service using at least a portion of the set of service progress data, wherein the service information is based, at least in part, on a service location of the transport service.

19. The non-transitory computer-readable medium of claim 18, wherein the executed instructions further cause the mobile computing device to present the user interface in the first configuration as a default configuration of the user interface based on the set of service progress data indicating that the service provider identified by the remote computing system is en-route to a start location of the transport service.

20. The non-transitory computer-readable medium of claim 18, wherein the executed instructions further cause the mobile computing device to:
while presenting the user interface in the second configuration, receive a second user input; and
in response to receiving the second user input while the user interface is presented in the second configuration, pivot the user interface from the second configuration back to the first configuration.
